(19) United States
(12) Patent Application Publication
(10) Pub. No.: US 2026/0079708 A1
(43) Pub. Date: Mar. 19, 2026

(54) MAPPING INSTRUCTIONS INCLUDED IN THREADS TO FUNCTIONAL UNITS OF PROCESSORS

(71) Applicant: Samsung Electronics Co., Ltd., Suwon-si (KR)

(72) Inventors: Tong ZHANG, Fremont, CA (US); Jianping ZENG, San Jose, CA (US); Da ZHANG, Fremont, CA (US); Rekha PITCHUMANI, Oak Hill, VA (US); Yang Seok KI, Palo Alto, CA (US)

(21) Appl. No.: 19/326,674

(22) Filed: Sep. 11, 2025

Related U.S. Application Data
(60) Provisional application No. 63/696,792, filed on Sep. 19, 2024.

(51) Int. Cl. G06F 9/30

(52) U.S. Cl. CPC G06F 9/3009; G06F 9/30065

(57) ABSTRACT

Mapping instructions included in threads to functional units of processors is disclosed. A first functional unit of a first processor may be identified that is underutilized for a first instruction included in a first thread of threads generated from a loop within source code. The first thread may be yielded to a second thread of the threads generated from the loop. A second instruction included in the second thread may be mapped to the first functional unit of the first processor.

### RELATED APPLICATION DATA

This application claims the benefit of U.S. Provisional Patent Application Ser. No. 63/696,792, filed Sep. 19, 2024, which is incorporated by reference herein for all purposes.

### FIELD

The disclosure relates generally to compiling source code for execution by hardware, and more particularly to mapping instructions included in threads to functional units of processors.

### BACKGROUND

Source code includes instructions written in a human-readable programming language.

In order to perform these instructions using hardware, the source code is compiled/converted into machine code which can be read/processed by the hardware. An operating system of the hardware typically organizes portions of the machine code for execution by a processor included in the hardware. The processor executes the portions of the machine code which performs the instructions included in the source code.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 illustrates a system including resources and source code to be compiled for execution by the resources, according to embodiments of the disclosure.

FIG. 2 illustrates a memory die of a memory device, according to embodiments of the disclosure.

FIG. 3 illustrates a base die of a memory device, according to embodiments of the disclosure.

FIG. 4 illustrates a processing circuit, according to embodiments of the disclosure.

FIG. 5 illustrates an example of a first set of resources, according to embodiments of the disclosure.

FIG. 6 illustrates an example of a second set of resources, according to embodiments of the disclosure.

FIG. 7 illustrates a representation of a processor with low utilization, according to embodiments of the disclosure.

FIG. 8 illustrates example logic for mapping instructions included in threads to functional units of processors, according to embodiments of the disclosure.

FIG. 9 illustrates a representation of a processor with high utilization, according to embodiments of the disclosure.

FIG. 10 illustrates a representation of machine code generated for a first set of resources, according to embodiments of the disclosure.

FIG. 11 illustrates a representation of machine code generated for a second set of resources, according to embodiments of the disclosure.

FIG. 12 shows a flowchart of an example procedure for mapping instructions included in threads to functional units of processors, according to embodiments of the disclosure.

### SUMMARY

A first functional unit of a first processor may be identified that is underutilized for a first instruction included in a first thread of threads generated from a loop within source code. The first thread may be yielded to a second thread of the threads generated from the loop. A second instruction included in the second thread may be mapped to the first functional unit of the first processor.

A system may include at least one memory and at least one compute device coupled to the at least one memory. The at least one compute device may be configured to identify a first functional unit of a first processor that is underutilized based on a first yield added for a first thread of threads generated from a loop within source code. The at least one compute device may be configured to add a second yield for a second thread of the threads generated from the loop. The at least one compute device may be configured to map an instruction included in a third thread of the threads generated from the loop to the first functional unit of the first processor.

A first functional unit of a first processor may be identified that is underutilized for a first instruction included in a first thread of threads generated from a loop within source code. The first thread may be yielded to a second thread of the threads generated from the loop. A second instruction included in the second thread may be mapped to the first functional unit of the first processor. Generation of machine code may be caused based on mapping the second instruction to the first functional unit of the first processor.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Source code may be written using a parallel programming model such that compiling the source code into machine code generates threads of instructions that may be processed in parallel. At runtime, the threads may cause different instructions included in the source code to be executed by hardware resources (e.g., in parallel). Some hardware resources include a base die that can be attached/connected to a memory die.

The base die can have multiple processing circuits that may include one or more processors having functional units that may be underutilized for processing instructions included in threads. For example, a processor included in the base die may have a functional unit capable of four parallel operations (e.g., in one cycle) but the functional unit may only perform one operation because threads with instructions that could be performed using another one of the four parallel operations may not be available. In this example, the functional unit performs one operation because only one thread is available; however, the functional unit could perform three additional operations for instructions included in three additional threads if these additional threads were available for parallel execution.

In some embodiments, a compiler may be capable of modifying calls/code inserted into a binary file when compiling the source code in order to increase a likelihood that threads with instructions performable by the underutilized functional unit will be available (e.g., to increase utilization of the processor). For instance, the functional unit may be identified as underutilized for a first instruction included in a first thread of threads generated from a loop within the source code. In some embodiments, the functional unit may be identified as underutilized using one or more performance monitoring counters (PMCs) for the functional unit. In these embodiments, the PMCs may count actual operations performed by the functional unit which can be compared to a corresponding performance capacity in order to identify the functional unit as underutilized.

In some embodiments, the compiler may insert a yield function into the binary file that causes the first thread to yield to a second thread of the threads generated from the loop. A second instruction included in the second thread may be mapped to the functional unit of the processor. In some embodiments, an operating system may map the second instruction of the second thread to the functional unit in order to increase utilization of the functional unit. If the functional unit (or another functional unit) of the processor is not fully utilized, then the compiler may be configured to insert calls/code into the binary file that increase a number of the threads generated from the loop within the source code.

In some embodiments, after increasing the number of the threads generated from the loop, a third instruction included in a third thread may be mapped to the functional unit. By modifying calls/code inserted into the binary file to yield threads and increase thread counts, the compiler facilitates increased (and more efficient) utilization of the processor included in the base die. Notably, the utilization of the processor may be increased without modifying the source code.

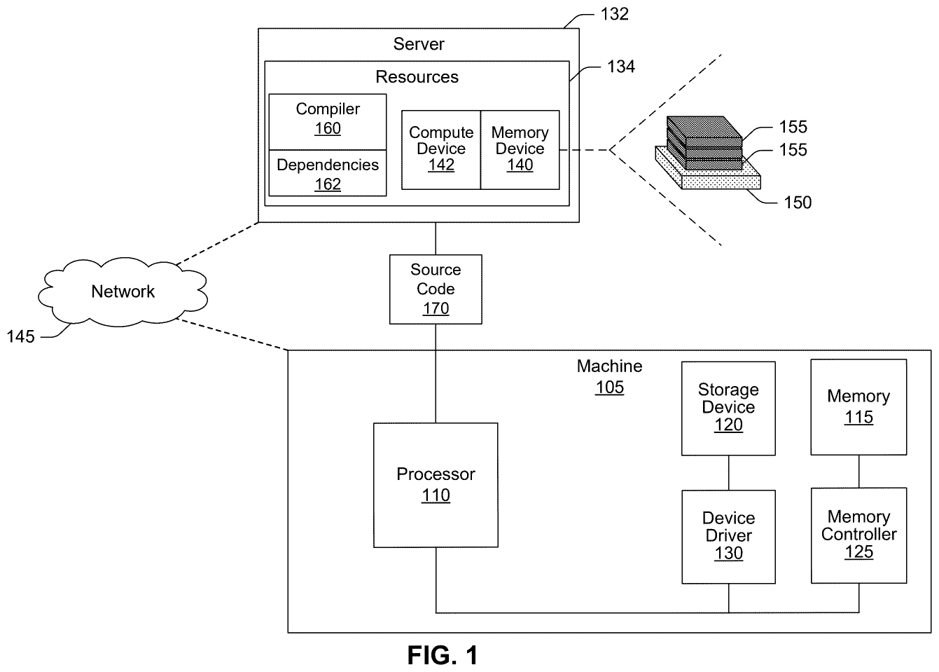

FIG. 1 illustrates a system including resources 134 and source code 170 to be compiled for execution by the resources 134, according to embodiments of the disclosure. As shown in FIG. 1, a machine 105 (e.g., a host) includes a processor 110, a memory 115, and a storage device 120. The processor 110 is representative of a variety of types of processors such as central processing units (CPUs), accelerators, graphics processing units (GPUs), processors implemented using field-programmable gate arrays (FPGAs) (e.g., soft processors), etc. The memory 115 can include volatile memory and/or non-volatile memory and the memory 115 is representative of a variety of types of memory such as random access memory (RAM), static RAM (SRAM), dynamic RAM (DRAM), synchronous DRAM (SDRAM), etc.

Read/write operations performed relative to the memory 115 may be managed by a memory controller 125. In the illustrated example, the processor 110 is communicatively coupled to the memory controller 125 via a wired or wireless connection. The processor 110 is also shown to be communicatively coupled to the storage device 120 via a device driver 130. The device driver 130 can control the storage device 120 and the device driver 130 may be implemented using software, hardware, or a combination of software and hardware.

The system shown in FIG. 1 is illustrated to include a server 132 having resources 134 which may include one or more memory devices 140 and one or more compute devices 142. Although the server 132 is illustrated as a single server, it is to be appreciated that, in some embodiments, the resources 134 may be distributed across multiple servers 132. The compute devices 142 may include one or more processors such as CPUs, application specific integrated circuits (ASICs), accelerators, GPUs, neural processing units (NPUs), tensor processing units (TPUs), etc. A memory device 140 can include one or more memory die 155 having volatile memory and/or non-volatile memory. In some embodiments, the memory device 140 may include one or more memory die 155 having a variety of types of memory such as DRAM, SRAM, magnetoresistive RAM (MRAM), phase change memory (PCM), Flash, read-only memory (ROM), and/or combinations of such.

In some embodiments, compute and/or memory resources included in the memory device 140 may be physically disposed in a three-dimensional stack (e.g., to minimize distances between locations of the resources). In the example depicted in FIG. 1, the memory device 140 is illustrated to include a base die 150 and one or more memory die 155 attached to the base die 150 in a three-dimensional stack. In some embodiments, compute and/or memory resources of the memory device 140 are connected to the base die 150 and/or the memory die 155. For instance, including compute and/or memory resources of the memory device 140 in a three-dimensional stack of the memory die 155 attached to the base die 150 may minimize power consumed and physical space occupied by the compute and/or memory resources. Although examples are described with respect to the memory die 155 attached to the base die 150, it is to be appreciated that, in some embodiments, compute and/or memory resources of the memory device 140 are included in other orientations (e.g., non-stacked orientations) and configurations (e.g., integrated configurations).

In some embodiments, the resources 134 may be communicatively coupled to the machine 105 via a wired or wireless connection. By way of example, the processor 110 may be connected to the server 132 via a network 145. In the illustrated example, the resources 134 of the server 132 include one or more compilers 160 and dependencies 162. For instance, the resources 134 may execute one or more compilers 160 (e.g., using one or more compute devices 142) and the resources 134 may store one or more dependencies 162 (e.g., using one or more memory devices 140).

It should be appreciated that, in some embodiments, a compiler 160 may include any compiler capable of compiling/converting source code 170 into machine code which is executable by the resources 134. For instance, the source code 170 may include instructions in a human-readable programming language and a user of the machine 105 may transmit the source code 170 to the server 132 via the network 145. In some embodiments, the compiler 160 uses the dependencies 162 in order to compile the source code 170 into the machine code that can be executed by the resources 134.

In some embodiments, the dependencies 162 may include source-level dependencies (e.g. build dependencies) and data-level dependencies (e.g., code dependencies) which are relied upon by the compiler 160 in order to compile the source code 170 into the machine code. The dependencies 162 can include library dependencies that may be explicitly referenced by the source code 170. For example, the dependencies 162 may include a particular library having defined mathematical functions and the source code 170 may utilize the mathematical functions by explicitly referencing the particular library. The dependencies 162 can also include runtime dependencies, build-time dependencies, hardware dependencies, and/or other dependencies. In some embodiments, the dependencies 162 may include header files, static libraries, directives, configuration files, and/or other resources that the compiler 160 utilizes to compile the source code 170 into the machine code. For instance, the compiler 160 and the dependencies 162 may support parallel programming such that the source code 170 can be executed by multiple processors included in the resources 134.

In some embodiments, the compiler 160 and the dependencies 162 may support an application programming interface (API) for parallel programming such as Open Multi-Processing (OpenMP). In these embodiments, when compiling the source code 170 using OpenMP, the compiler 160 recognizes OpenMP directives based on the dependencies 162 and the compiler 160 inserts calls/code into a binary file including the machine code to generate threads. At runtime, these threads may cause different instructions included in the source code 170 to be executed in parallel by the resources 134.

In some embodiments, the resources 134 may include one or more processors having capabilities or functional units that may be underutilized for processing instructions included in threads (e.g., threads generated using OpenMP). Examples of functional units in processors of the resources 134 may include arithmetic logic units (e.g., configured to perform integer arithmetic), floating point units (e.g., configured to perform floating point arithmetic), load/store units (e.g., configured to perform memory operations), multiplication/division units, and/or specialized units (e.g., configured for cryptography or artificial intelligence operations). In some embodiments, different processors in the resources 134 may include different functional units (e.g., a first processor may include a first set of functional units and a second processor may include a second set of functional units). For example, a processor included in the resources 134 may have a functional unit capable of four parallel operations (e.g., in one cycle) but the functional unit may only perform one operation. In this example, threads with instructions that could be performed by the functional unit using another one of the four parallel operations may not be available, for example, based on the machine code generated by compiling the source code 170 using OpenMP.

In some embodiments, the functional unit may be identified as underutilized using one or more performance monitoring counters (PMCs) for the functional unit. In these embodiments, a performance monitoring unit of the processor included in the resources 134 can have multiple PMCs configured to identify an underutilization of the functional unit. For instance, a PMC may count actual operations performed by the functional unit which can be compared to a performance capacity of the functional unit (e.g., a theoretical number of operations performed) in order to identify the functional unit as underutilized. It is to be appreciated that, in some embodiments, functional units may be identified as underutilized using various techniques in addition or alternative to utilizing the PMCs. In some embodiments, the functional unit may be identified as underutilized based on one or more simulations of executing machine code generated by compiling the source code 170. In these embodiments, the one or more simulations can be performed before executing the machine code or in substantially real time while executing the machine code.

In some embodiments, the compiler 160 may be capable of modifying the calls/code inserted into the binary file in order to increase a likelihood that threads with instructions performable by the underutilized functional unit will be available to increase utilization of the processor. For instance, the compiler 160 may be capable of modifying performance of instructions in loops included in the source code 170 such that the corresponding machine code may be executed more efficiently by the resources 134.

Consider the example above in which the functional unit of the processor is underutilized for processing instructions included in a first thread of threads generated from a loop within the source code 170. The compiler 160 may be configured to insert a yield instruction into the binary file such that the first thread may yield to a second thread of the threads generated from the loop (e.g., at runtime or during execution of the machine code compiled from the source code 170). For instance, the second thread includes instructions that can be performed by the functional unit using a second one of the four parallel operations.

Continuing the example, if the functional unit of the processor is still underutilized for the instructions included in the second thread, then the compiler 160 may be configured to increase a number of the threads generated from the loop (e.g., by inserting code into the binary file). In some embodiments, increasing the number of the threads may generate a third thread and a fourth thread having instructions which can be performed by third and fourth ones of the four parallel operations of the functional unit, respectively. By modifying the calls/code inserted into the binary file, the compiler 160 increases utilization (and efficiency) of the processor included in the resources 134 without modifying the source code 170.

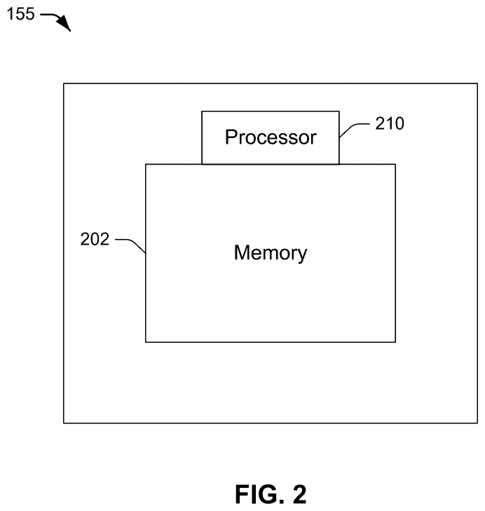

FIG. 2 illustrates a memory die 155 of a memory device 140, according to embodiments of the disclosure. As shown, a memory die 155 includes a memory 202. The memory 202 can include volatile memory and/or non-volatile memory and the memory 202 is representative of a variety of types of memory such as DRAM, SRAM, MRAM, PCM, Flash, ROM, and/or combinations of such. Accordingly, FIG. 2 depicts an example in which memory resources (e.g., the memory 202) of the memory device 140 are included in the memory die 155. In some embodiments, the memory die 155 includes one memory, two memories, more than two memories, etc. In some embodiments, the memory die 155 is a DRAM die, and the memory 202 represents DRAM.

In some optional embodiments, the memory die 155 includes a processor 210. Like the processor 110, the processor 210 is representative of a variety of types of processors such as CPUs, ASICs, accelerators, GPUs, NPUs, TPUs, etc. In the illustrated example, the processor 210 is coupled to the memory 202. Thus, FIG. 2 depicts an example in which memory resources (e.g., the memory 202) and compute resources (e.g., the processor 210) of the memory device 140 are included in the memory die 155. Although the example shown in FIG. 2 includes the processor 210, it is to be appreciated that, in some embodiments, the memory die 155 can include additional processors which may be structurally similar to the processor 210 or different from the processor 210. In some embodiments, the memory die 155 is included in a stack of multiple memory die 155 (as shown in FIG. 1) and each memory die 155 in the stack may include the processor 210.

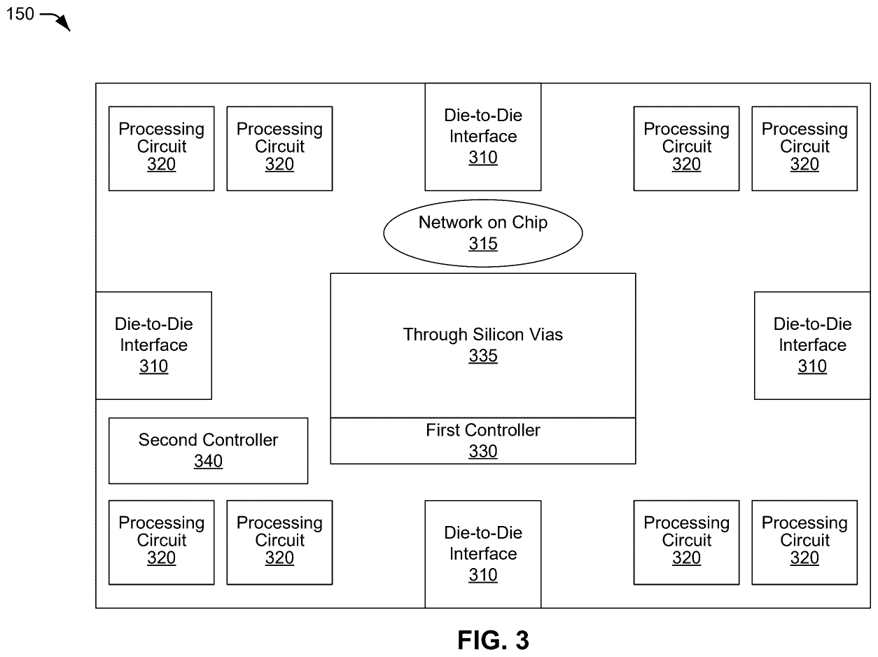

FIG. 3 illustrates a base die 150 of a memory device 140, according to embodiments of the disclosure. As shown, a base die 150 can include one or more die-to-die interfaces 310, a network on chip 315, one or more processing circuits 320, a first controller 330, through silicon vias 335, and a second controller 340. In an example in which the memory die 155 illustrated in FIG. 2 is a DRAM die, the first controller 330 may be a memory controller (e.g., a DRAM controller) configured to control the memory 202 using the through silicon vias 335.

As shown in FIG. 3, the first controller 330 can be connected to the through silicon vias 335. For instance, the through silicon vias 335 can communicatively couple (e.g., by multiple electrical connections) the memory 202 of the memory die 155 to the first controller 330 of the base die 150. In a particular example, controller logic (CTL) of the first controller 330 can issue a command to a physical interface/layer (PHY) which converts the command into a signal for transmission to the memory die 155 by the through silicon vias 335. In the particular example, the through silicon vias 335 may transmit data read from the memory 202 of the memory die 155 to the PHY and the CTL. Although FIG. 3 is illustrated to include the through silicon vias 335, it is to be appreciated that, in some embodiments, hybrid bonding (e.g., dielectric-to-dielectric connections and conductor-to-conductor connections in a stacked configuration) may be used in addition or alternative to the through silicon vias 335.

In some embodiments, the die-to-die interfaces 310 are configured to interface with one or more additional dies and/or various types of compute and/or memory resources, as described below. The die-to-die interfaces 310 are representative of multiple different types of physical interfaces which can support different interface protocols/specifications such as universal chiplet interconnect express (UCIe), bunch of wires (BOW), advanced interface bus (AIB), opensource protocols/specifications (e.g., OpenHBI), etc. Although FIG. 3 illustrates four die-to-die interfaces 310, it is to be appreciated that, in some embodiments, the base die 150 includes less than four die-to-die interfaces 310 or more than four die-to-die interfaces 310.

As shown in FIG. 3, the base die 150 includes the network on chip 315 which may be internal to the base die 150 (e.g., integrated into the base die 150). The network on chip 315 may be configured to communicatively couple various devices/components (e.g., in a network-based architecture). For instance, the network on chip 315 may be configured to interface with an accelerator link, a memory controller, etc. In some embodiments, the network on chip 315 may connect the die-to-die interfaces 310 to the processing circuits 320, the first controller 330, the second controller 340, etc. In some embodiments, the network on chip 315 may communicatively couple the processing circuits 320 to each other and/or to the second controller 340.

The processing circuits 320 include compute and/or memory resources of the base die 150 of the memory device 140. In some embodiments, compute and/or memory resources are included in the processing circuits 320 in addition or alternative to compute and/or memory resources included in the memory die 155 of the memory device 140. In some embodiments, the second controller 340 is configured to control the processing circuits 320 by controlling or triggering kernel execution by the processing circuits 320. The second controller 340 can represent or include a management CPU configured to control operations of the processing circuits 320 such as setting parameters, collecting results, transmitting commands, etc.

Although the first controller 330 and the second controller 340 are illustrated as two controllers, it is to be appreciated that, in some embodiments, the first controller 330 and the second controller 340 are implemented as a single controller. It also should be appreciated that by including the processing circuits 320 as part of the base die 150 in relatively close proximity to data (e.g., near the memory 202 of the memory die 155), the processing circuits 320 have faster access to the data at lower energy costs compared to an example in which the processing circuits 320 are not in relatively close proximity to the data. While eight processing circuits 320 are shown, it should be appreciated that, in some embodiments, the base die 150 includes more than eight processing circuits 320 or less than eight processing circuits 320. Additionally, it should be appreciated that the processing circuits 320 can be structured similarly such that a first one of the processing circuits 320 has first hardware and/or software and a second one of the processing circuits 320 has the first hardware and/or software. It is also to be appreciated that the processing circuits 320 may be different such that the first one of the processing circuits 320 has the first hardware and/or software and the second one of the processing circuits 320 has second hardware and/or software.

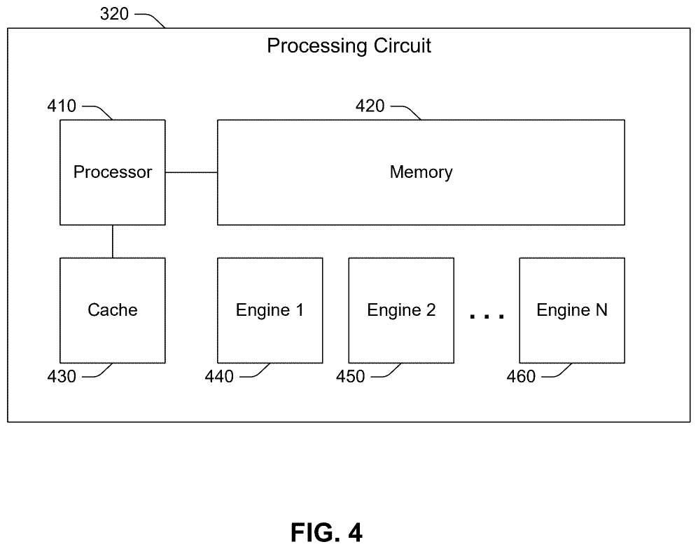

FIG. 4 illustrates a processing circuit 320, according to embodiments of the disclosure. As shown in FIG. 4, a processing circuit 320 includes a processor 410 and a memory 420. In some embodiments, the processing circuit 320 may include a cache 430 as well as engines 440, 450, 460. The processor 410 is representative of a variety of types of processors such as CPUs, accelerators, GPUs, NPUs, TPUs, etc. In some embodiments, the processor 410 includes multiple processors which may be different types of processors (e.g., a GPU, an NPU, and/or a TPU). In general, the processor 410 is configured to execute instructions which may be included in the memory 420, the cache 430, and/or an additional memory/cache. Accordingly, in some embodiments, the processor 410 is connected to the memory 420, the cache 430, and/or the additional memory/cache. Executing the instructions may cause the processor 410 to perform one or more operations.

The memory 420 can include volatile memory and/or non-volatile memory. In some embodiments, the memory 420 includes tightly coupled memory (TCM) which may be a nearest or fastest memory accessible to the processing circuit 320. In some embodiments, the memory 420 may be SRAM. The memory 420 may be private to the processing circuit 320 (e.g., not accessible to another processing circuit 320) or the memory 420 may be accessible to a processor outside of the processing circuit 320 such as a processor included in an additional processing circuit 320 on the base die 150.

It should be appreciated that, in some embodiments, the memory 420 can be partitioned such that a first portion of the memory 420 is private to the processing circuit 320 and a second portion of the memory 420 is accessible to other processing circuits 320. For instance, the first portion of the memory 420 that is private to the processing circuit 320 may not be used by the other processing circuits 320 (e.g., the other processing circuits 320 may not read from or write to the first portion of the memory 420). In some embodiments, the second portion of the memory 420 that is accessible to the other processing circuits 320 may be used by the other processing circuits 320 (e.g., the other processing circuits 320 can read from and write to the second portion of the memory 420).

In some embodiments, the engines 440, 450, 460 include compute engines (e.g., co-processors, logic blocks, arithmetic units, etc.) which may be configured to execute particular instructions or perform specialized operations. For example, the engines 440, 450, 460 may include cryptographic engines, compression engines, video processing engines, database processing engines, graphics engines, gaming engines, domain specific engines, etc. In some embodiments, the engine 440 includes a general matrix multiply engine and the engine 450 includes a math engine. The general matrix multiply engine can be configured for matrix-to-matrix multiplication acceleration and the math engine may be configured to process element-wise operations on floating point numbers (e.g., including basic math, exponentiation, and trigonometric functions).

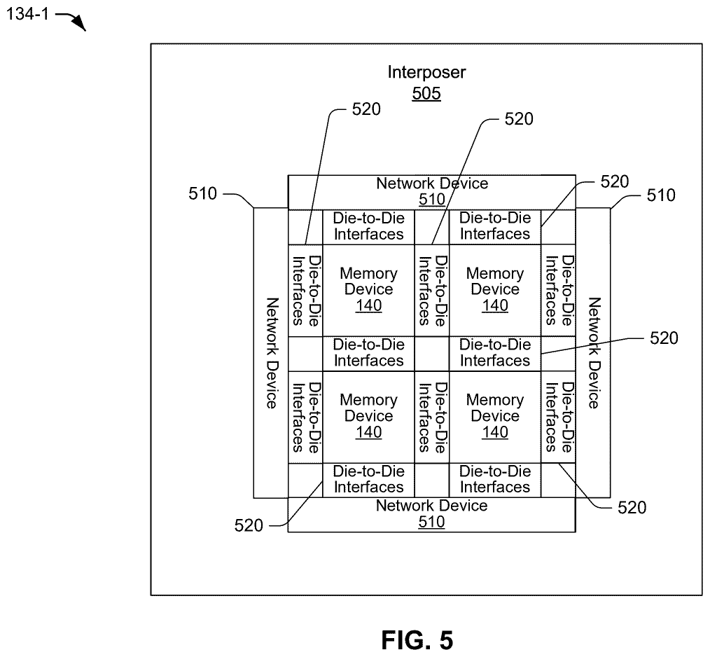

FIG. 5 illustrates an example of a first set of resources 134-1, according to embodiments of the disclosure. The first set of resources 134-1 may be included in the resources 134. In some embodiments, the resources 134 include multiple instances of the first set of resources 134-1. As depicted in FIG. 5, a first set of resources 134-1 may include one or more interposers 505, one or more memory devices 140, one or more network devices 510, and one or more die-to-die interfaces 520. The interposers 505 (e.g., silicon interposers) may be configured to communicatively couple some portions of the first set of resources 134-1 to other portions of the first set of resources 134-1.

In some embodiments, one or more interposers 505 may be configured to connect the first set of resources 134-1 with another first set of resources 134-1 or multiple other first sets of resources 134-1. Accordingly, the interposers 505 can comprise multiple smaller interposers 505 and the interposers 505 may be combined into larger interposers 505 (e.g., having a larger effective/functional area). For instance, one or more interposers 505 may represent or include bridges (e.g., silicon bridges), substrates, connection circuitry, package substrates, etc.

In the example shown in FIG. 5, the memory devices 140 are connected to the network devices 510 by die-to-die interfaces 520. Also, the memory devices 140 are illustrated to be connected to other memory devices 140 by die-to-die interfaces 520. In some embodiments, die-to-die interfaces 520 include one or more connections. For example, die-to-die interfaces 520 may include pairs of connected die-to-die interfaces 310 which may be connected by an interposer 505 in some embodiments (e.g., the interposer 505 may include a bridge that connects the die-to-die interfaces 310). For instance, die-to-die interfaces 520 may include a first die-to-die interface 310 of a memory device 140 and a second die-to-die interface 310 of a network device 510 or a second die-to-die interface 310 of another memory device 140. In some embodiments, die-to-die interfaces 520 can include various types of connections which are not limited to pairs of connected die-to-die interfaces 310.

In some embodiments, the network devices 510 may be configured to communicatively couple various devices/components in a network-based architecture (e.g., using links/interfaces). For instance, a network device 510 may be structured similarly to (or the same as) the network on chip 315 described above. In some embodiments, the network devices 510 may be configured to connect the first set of resources 134-1 to one or more additional memory devices 140, one or more additional first sets of resources 134-1, various other systems/devices included in the resources 134, etc.

In the first set of resources 134-1 shown in FIG. 5, the memory devices 140 are connected to the other memory devices 140 by die-to-die interfaces 520. In some embodiments, the memory devices 140 are connected in a mesh network such that each memory device 140 is connected to every other memory device 140 included in the first set of resources 134-1. In these embodiments, the memory devices 140 may directly communicate with neighboring/adjacent memory devices 140 in all directions. By leveraging the mesh network, a first memory device 140 may access memory and/or compute resources of a second memory device 140 in addition or alternative to memory and/or compute resources of the first memory device 140 in an efficient manner.

It should be appreciated that, in some embodiments, the memory devices 140 include both memory resources (e.g., the memory 202) and compute resources (e.g., the processing circuits 320). Accordingly, the first set of resources 134-1 is capable of performing operations that are compute intensive. The first set of resources 134-1 is also capable of performing operations that are memory intensive.

Although FIG. 5 depicts four memory devices 140 that each include four die-to-die interfaces 310, it should be appreciated that the first set of resources 134-1 may include any number of memory devices 140 which can each include any number of die-to-die interfaces 310. Additionally, while FIG. 5 illustrates two memory devices 140 in each of two rows, in some embodiments, the first set of resources 134-1 includes memory devices 140 in other array-like arrangements, for example: two memory devices 140 in a 1×2 matrix, nine memory devices 140 in a 3×3 matrix, 16 memory devices 140 in a 4×4 matrix, etc. Additionally, while the memory devices 140 are illustrated in FIG. 5 to be the same or similar (e.g., a homogeneous system), in some embodiments, a first one of the memory devices 140 can be different from a second one of the memory devices 140. For example, the first and second ones of the memory devices 140 can have different processing capabilities, different memory capabilities, different interface capabilities, etc.

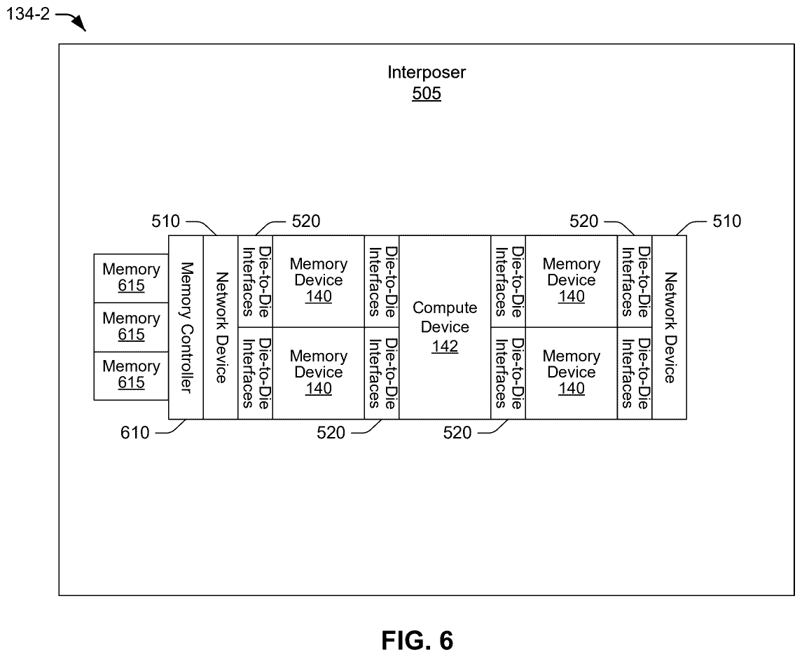

FIG. 6 illustrates an example of a second set of resources 134-2, according to embodiments of the disclosure. The second set of resources 134-2 may be included in the resources 134. In some embodiments, the resources 134 include multiple instances of the second set of resources 134-2. As depicted in FIG. 6, a second set of resources 134-2 may include one or more interposers 505, one or more memory devices 140, one or more compute devices 142, one or more network devices 510, one or more die-to-die interfaces 520, one or more memory controllers 610, and one or more memories 615. In the example shown, the memory devices 140 are connected to the network devices 510 by die-to-die interfaces 520 and the memory devices 140 are also connected to a compute device 142 by die-to-die interfaces 520.

In general, the compute device 142 may be configured to manage/control operations of the second set of resources 134-2. In some embodiments, the compute device 142 includes one or more processors such as CPUs, accelerators, GPUs, NPUs, TPUs, etc. For instance, the compute device 142 may have greater processing/computing capacity than processing circuits 320 included in the base die 150 of the memory devices 140. In some embodiments, the compute device 142 includes the functionality of the second controller 340 which the compute device 142 uses to control the processing circuits 320 included in the memory devices 140.

As illustrated in FIG. 6, a network device 510 may be configured to interface with one or more memory modules such as a memory controller 610. In the illustrated example, the memory controller 610 is communicatively coupled to one or more memories 615. The memories 615 can include volatile memory and/or non-volatile memory. In some embodiments, the memory controller 610 may include a low-power double data rate (LPDDR) memory controller and the one or more memories 615 may include one or more LPDDR memories, e.g., to expand memory resources of the memory die 155 of the memory devices 140. For instance, the memories 615 can provide additional memory resources to supplement memory resources of the memory 202 of the memory die 155 used by the base die 150.

Although FIG. 6 depicts four memory devices 140 that each include two die-to-die interfaces 310, it should be appreciated that the second set of resources 134-2 may include any number of memory devices 140 which can each include any number of die-to-die interfaces 310. Additionally, while FIG. 6 illustrates two memory devices 140 in each of two rows, in some embodiments, the second set of resources 134-2 includes memory devices 140 in other arrangements. For example, the other arrangements may include six memory devices 140, eight memory devices 140, 16 memory devices 140, etc. Further, while the memory devices 140 are illustrated in FIG. 6 to be the same or similar, in some embodiments, a first one of the memory devices 140 can be different from a second one of the memory devices 140.

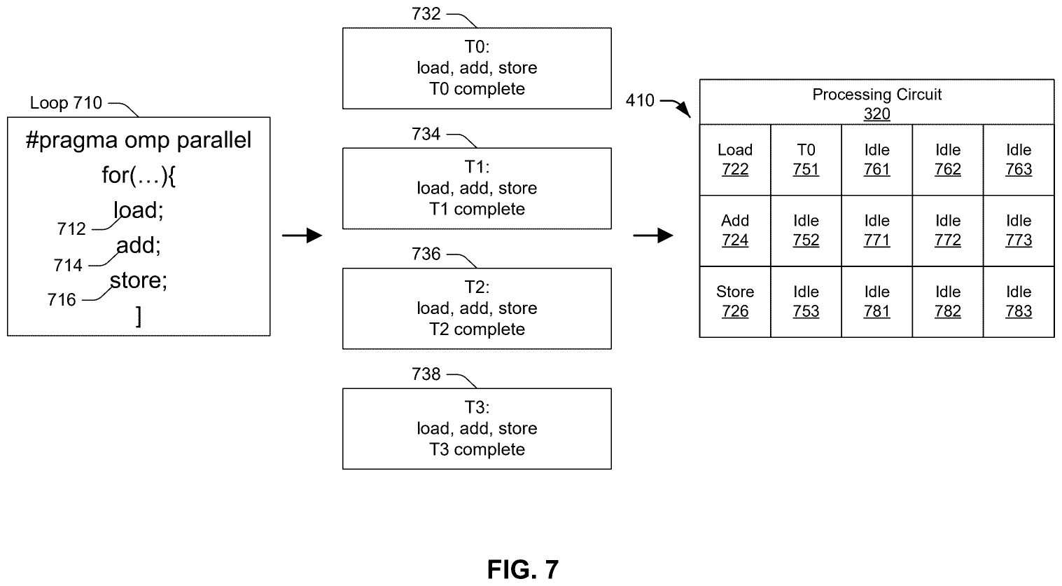

FIG. 7 illustrates a representation of a processor 410 with low utilization, according to embodiments of the disclosure. The processor 410 is illustrated to be included in a processing circuit 320. It is to be appreciated that, in some embodiments, the processing circuit 320 may be included in the resources 134 such as in the first set of resources 134-1, the second set of resources 134-2, and/or other sets of resources.

The processor 410 is depicted as including a first functional unit 722, a second functional unit 724, and a third functional unit 726. In the illustrated example, the first functional unit 722 and the third functional unit 726 are included in direct memory access (DMA) or a load/store unit to perform load operations and store operations, respectively. The second functional unit 724 is included in an arithmetic logic unit (ALU) to perform addition (add) operations.

As shown in FIG. 7, the representation includes a loop 710 of the source code 170. The loop 710 is illustrated to include a first instruction 712 (a load instruction), a second instruction 714 (an add instruction), and a third instruction 716 (a store instruction). In some embodiments, the first functional unit 722 can perform operations to execute instances of the first instruction 712, the second functional unit 724 can perform operations to execute instances of the second instruction 714, and the third functional unit 726 can perform operations to execute instances of the third instruction 716.

In the illustrated example, the source code 170 is written using a parallel programming model such that when compiling the source code 170, the compiler 160 inserts code into the binary file which generates threads from the loop 710 as described above. For instance, the threads generated from the loop 710 may include any of the first, second, and third instructions 712, 714, 716. In some embodiments, instructions included in different ones of the threads generated from the loop 710 may be performed in parallel using the first, second, and third functional units 722, 724, 726.

An operating system of the processing circuit 320 (e.g., an operating system of the second controller 340) or an operating system of a compute device 142 organizes/schedules the threads generated from the loop 710 into a first group 732 having thread T0, a second group 734 having thread T1, a third group 736 having thread T2, and a fourth group 738 having thread T3.In the first group 732, thread T0 includes the first, second, and third instructions 712, 714, 716 which are to be completed before processing the second group 734. In the second group 734, thread T1 also includes the first, second, and third instructions 712, 714, 716 that are to be completed before processing the third group 736.

As illustrated in FIG. 7, since the first group 732 is to be completed before processing the second group 734, the first instruction 712 included in the thread T0 is mapped to the first functional unit 722 of the processor 410 in a parallel operation 751. As shown, the first functional unit 722 is underutilized because parallel operations 761-763 are idle and not utilized. As further shown, the second and third functional units 724, 726 are not utilized.

As described above, the first functional unit 722 may be identified as underutilized using one or more PMCs for the first functional unit 722. For instance, a PMC may count actual operations performed by the first functional unit 722 which can be compared to a performance capacity of the first functional unit 722 in order to quantify and/or approximate utilization of the first functional unit 722. It is to be appreciated that, in some embodiments, the first functional unit 722 may be identified as underutilized if a utilization of the first functional unit 722 (e.g., actual operations performed divided by potential operations performed) is less than 50 percent, less than 25 percent, or less than another utilization percentage.

For instance, a parallel operation 752 of the second functional unit 724 is idle but the parallel operation 752 may be utilized to perform the second instruction 714 included in thread T0 in another cycle. Parallel operations 771-773 of the second functional unit 724 are idle and not utilized. Similarly, a parallel operation 753 of the third functional unit 726 is idle but the parallel operation 753 may be utilized to perform the third instruction 716 included in thread T0 in a future cycle. Parallel operations 781-783 of the third functional unit 726 are idle and not utilized.

The processor 410 with low utilization depicted in FIG. 7 is undesirable for various reasons (e.g., increased latency, inefficiency, etc.). In order to increase utilization of the processor 410, the first instruction 712 included in thread T1 of the second group 734 may be mapped to the first functional unit 722 of the processor 410 (e.g., in one of the parallel operations 761-763). It is to be appreciated that, in some embodiments, utilization of the processor 410 can be further increased by mapping the first instruction 712 included in thread T2 of the third group 736 and/or the first instruction 712 included in thread T3 of the fourth group 738 to the first functional unit 722 of the processor 410.

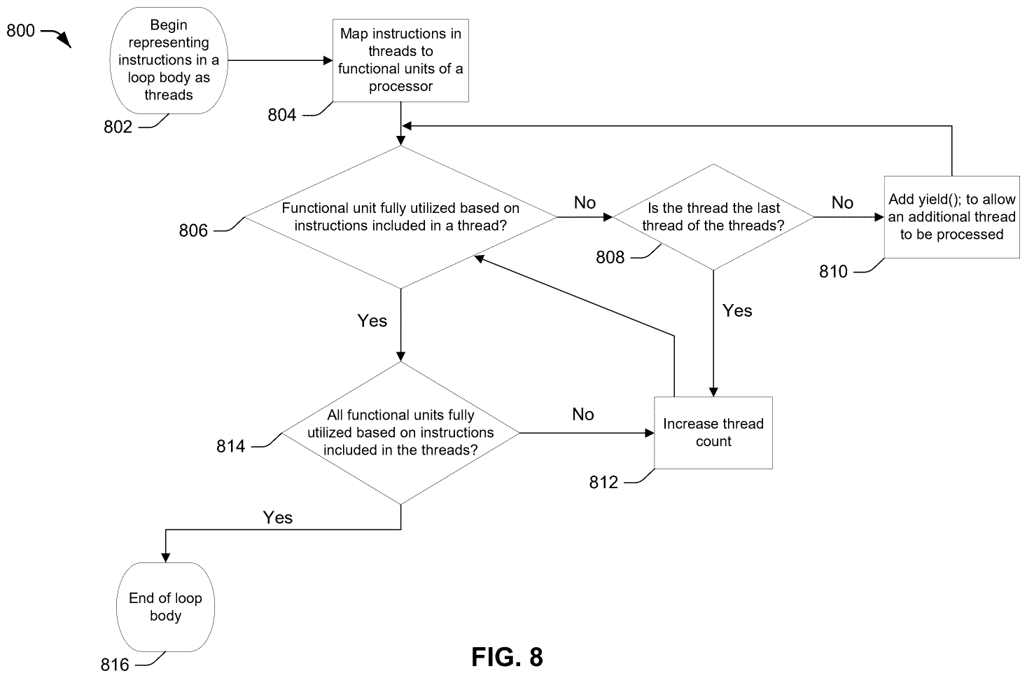

FIG. 8 illustrates example logic 800 for mapping instructions included in threads to functional units of processors, according to embodiments of the disclosure. In some embodiments, the example logic 800 may be implemented using the first set of resources 134-1 and/or the second set of resources 134-2. In some embodiments, the functional units of the processors may be included in the first set of resources 134-1 or the functional units of the processors may be included in the second set of resources 134-2. As shown in FIG. 8, at operation 802, representing instructions in a loop body as threads begins. At operation 804, instructions in threads are mapped to functional units of a processor.

At operation 806, it is determined whether a functional unit is fully utilized based on instructions included in a thread of the threads. In some embodiments, if the logic 800 returns to operation 806, then at operation 806, it is determined whether a functional unit (that was previously not fully utilized) is fully utilized based on instructions included in the thread of the threads. If the functional unit is not fully utilized based on instructions included in the thread (no), then the logic 800 may continue to operation 808. At operation 808, it is determined whether the thread is the last thread of the threads. If the thread is not the last thread of the threads (no), then the logic 800 may continue to operation 810.

At operation 810, a “yield( );” is added to the binary file to allow an additional thread of the threads to be processed and the logic 800 may continue to operation 806. At operation 808, if the thread is the last thread of the threads (yes), then the logic 800 may continue to operation 812. At operation 812, a number of the threads representing instructions in the loop body is increased by increasing a thread count and the logic 800 may continue to operation 806.

Consider an example in which the functional unit is not fully utilized based on first instructions included in a first thread of the threads. In this example, adding the “yield( )” at operation 810 yields the first thread to a second thread of the threads that includes second instructions. For instance, the functional unit may be underutilized based on the first instructions included in the first thread and yielding the first thread to the second thread may be configured to increase utilization of the functional unit based on the second instructions.

However, in some embodiments, the functional unit may not be fully utilized based on the second instructions included in the second thread of the threads. For example, the second instructions may be the same type of instructions as the first instructions that cause the functional unit to be underutilized. Accordingly, in some embodiments, increasing the number of threads by increasing the thread count at operation 812 may be configured to generate a new thread including different instructions. In some embodiments, utilization of the functional unit may be increased based on the different instructions included in the new thread.

At operation 806, if the functional unit is fully utilized based on instructions included in the thread (yes), then the logic 800 may continue to operation 814. At operation 814, it is determined whether all functional units are fully utilized based on instructions included in the threads. If all the functional units are not fully utilized based on instructions included in the threads (no), then the logic 800 may continue to operation 812. In some embodiments, returning to operation 812 may be configured generate additional new threads including additional instructions which may increase utilization of one or more underutilized functional units. If all the functional units are fully utilized based on instructions included in the threads (yes), then the logic 800 may continue to operation 816. At operation 816, the loop body ends.

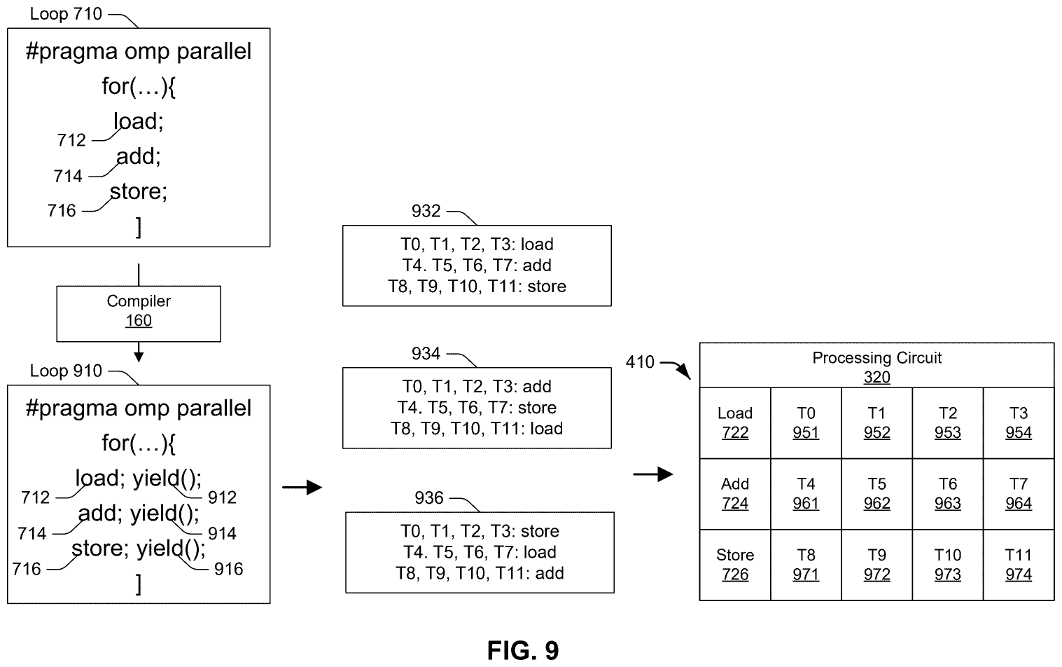

FIG. 9 illustrates a representation of a processor 410 with high utilization, according to embodiments of the disclosure. As shown, the representation includes the processing circuit 320 and the loop 710 of the source code 170 which are also illustrated in FIG. 7. Unlike FIG. 7, the representation of FIG. 9 depicts a loop 910 of machine code included in the binary file.

In some embodiments, the compiler 160 modifies the loop 910 by inserting yield instructions for some threads to yield to other threads and by increasing a number of threads generated from the loop 910 in order to increase utilization of the first, second, and third functional units 722, 724, 726 included in the processor 410. In the illustrated example, the compiler 160 has added a first yield 912, a second yield 914, and a third yield 916 to the loop 910. In some embodiments, the compiler 160 increases a number of the threads generated from the loop 910 (e.g., the compiler 160 may increase the number of the threads generated from the loop 910 multiple times).

The operating system of the processing circuit 320 (e.g., the operating system of the second controller 340) or the operating system of the compute device 142 organizes/schedules the threads generated from the loop 910 into a first group 932, a second group 934, and a third group 346 having threads T0-T11. As shown, threads T0-T3 include the first instruction 712; threads T4-T7 include the second instruction 714; and threads T8-T11 include the third instruction 716 in the first group 932. In the second group 934, threads T0-T3 include the second instruction 714; threads T4-T7 include the third instruction 716; and threads T8-T11 include the first instruction 712. Threads T0-T3 include the third instruction 716; threads T4-T7 include the first instruction 712; and threads T8-T11 include the second instruction 714 in the third group 936.

In the representation illustrated in FIG. 9, parallel operations 951-954 of the first functional unit 722 are utilized by threads T0-T3, respectively; parallel operations 961-964 of the second functional unit 724 are utilized by threads T4-T7, respectively; and parallel operations 971-974 of the third functional unit 726 are utilized by threads T8-T11, respectively. Accordingly, the processor 410 is fully utilized in the illustrated example. In some embodiments, the improved utilization of the processor 410 shown in FIG. 9 relative to the processor 410 shown in FIG. 7 may be based on differences in organizing/scheduling the first group 732 of FIG. 7 and the first group 932 of FIG. 9.

As described above, since the first group 732 is to be completed before processing the second group 734 and because the first group 732 includes a relatively small number of threads, the processor 410 illustrated in FIG. 7 is underutilized. However, in some embodiments, by adding the first, second, and/or third yields 912, 914, 916 to the loop 910 and by increasing the number of the threads generated from the loop 910, the first group 932 fully utilizes the processor 410 of FIG. 9. Notably, in some embodiments, the utilization of the processor 410 can be improved (as shown in FIG. 9) without changing the source code 170.

It is to be appreciated that, in some embodiments, the compiler 160 may access logic for adding yield instructions (e.g., the first, second, and/or third yields 912, 914, 916) to the loop 910. This logic may be included in the dependencies 162 and/or the compiler 160. In some embodiments, the logic may be based on rules and/or heuristics. In some embodiments, the logic may be based on a machine learning model trained on training data to add yield instructions that improve utilization of the processor 410. By way of example, the training data may include negative samples of added yields that did not improve utilization of the processor 410 and positive samples of added yields that did improve utilization of the processor 410.

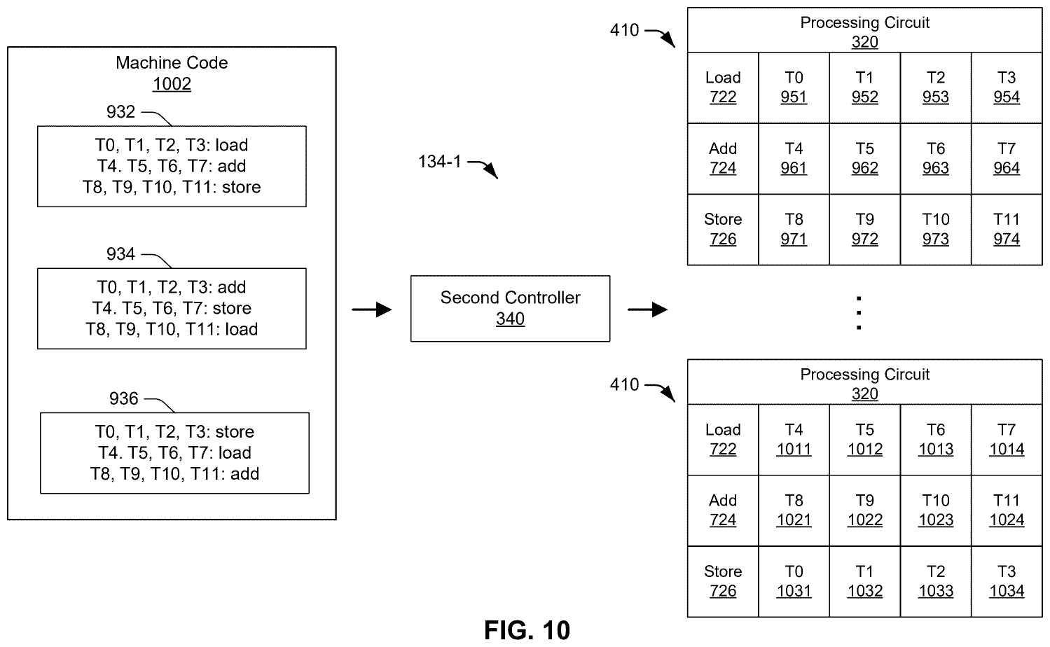

FIG. 10 illustrates a representation of machine code 1002 generated for a first set of resources 134-1, according to embodiments of the disclosure. As shown, the machine code 1002 is generated based on the source code 170 and the machine code 1002 includes the first group 932, the second group 934, and the third group 346. The representation includes a first processing circuit 320 having a processor 410 that is fully utilized for instructions included in the first group 932 as shown in FIG. 9.

In the example illustrated in FIG. 10, an operating system of the second controller 340 maps instructions included in threads T0-T3 to parallel operations 951-954 of the first functional unit 722, respectively; instructions included in threads T4-T7 to parallel operations 961-964 of the second functional unit 724, respectively; and instructions included in threads T8-T11 to parallel operations 971-974 of the third functional unit 726, respectively, for the first processing circuit 320. As shown in FIG. 10, the operating system of the second controller 340 maps instructions included in the third group 934 to a processor 410 of a second processing circuit 320. The operating system of the second controller 340 maps instructions included in threads T4-T7 to parallel operations 1011-1014 of a first functional unit 722, respectively; instructions included in threads T8-T11 to parallel operations 1021-1024 of a second functional unit 724, respectively; and instructions included in threads T0-T3 to parallel operations 1031-1034 of a third functional unit 726, respectively, for the second processing circuit 320.

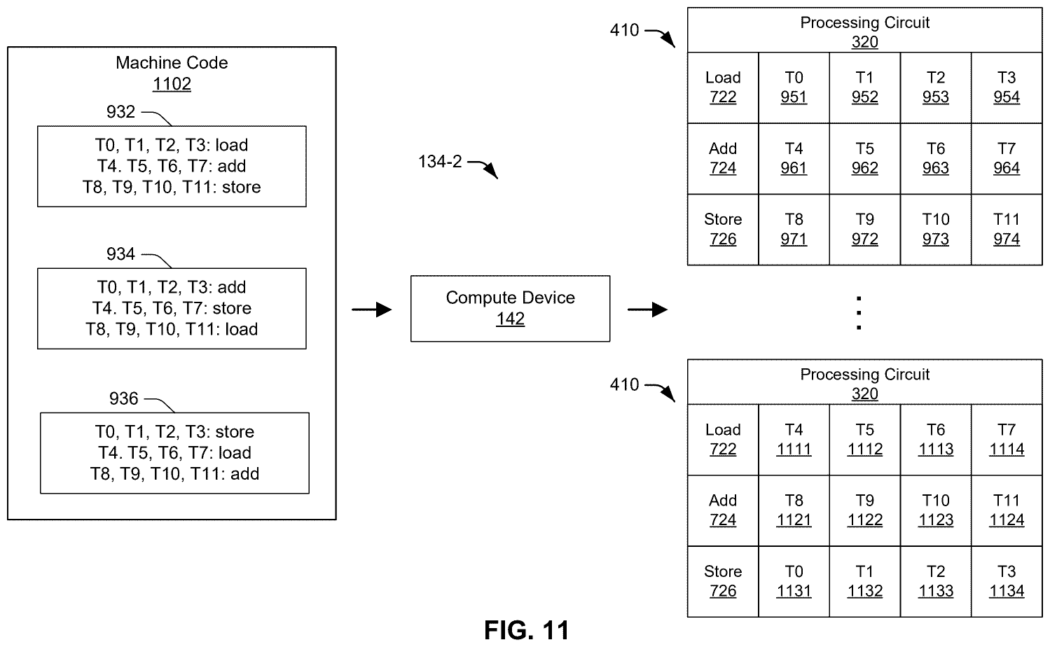

FIG. 11 illustrates a representation of machine code 1102 generated for a second set of resources 134-2, according to embodiments of the disclosure. As shown, the machine code 1102 is generated based on the source code 170. Like the machine code 1002 shown in FIG. 10, the machine code 1102 depicted in FIG. 11 includes the first group 932, the second group 934, and the third group 346. The representation of FIG. 11 includes a first processing circuit 320 having a processor 410 that is fully utilized for instructions included in the first group 932 as shown in FIG. 9.

In the example depicted in FIG. 11, an operating system of the compute device 142 maps instructions included in threads T0-T3 to parallel operations 951-954 of the first functional unit 722, respectively; instructions included in threads T4-T7 to parallel operations 961-964 of the second functional unit 724, respectively; and instructions included in threads T8-T11 to parallel operations 971-974 of the third functional unit 726, respectively, for the first processing circuit 320. As illustrated in FIG. 11, the operating system of the compute device 142 maps instructions included in the third group 934 to a processor 410 of a second processing circuit 320. The operating system of the compute device 142 maps instructions included in threads T4-T7 to parallel operations 1111-1114 of a first functional unit 722, respectively; instructions included in threads T8-T11 to parallel operations 1121-1124 of a second functional unit 724, respectively; and instructions included in threads T0-T3 to parallel operations 1131-1134 of a third functional unit 726, respectively, for the second processing circuit 320.

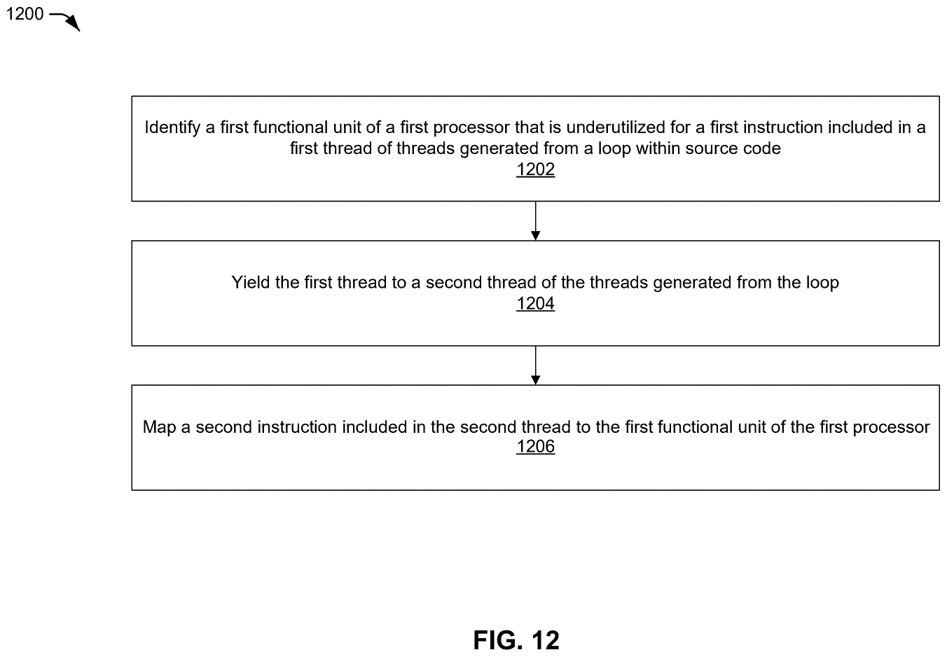

FIG. 12 shows a flowchart of an example procedure 1200 for mapping instructions included in threads to functional units of processors, according to embodiments of the disclosure. At block 1202, a first functional unit of a first processor is identified that is underutilized for a first instruction included in a first thread of threads generated from a loop within source code. In some embodiments, an operating system of the compute device 142 or the second controller 340 identifies the first functional unit that is underutilized. In some embodiments, the first functional unit of the first processor is included in first set of resources 134-1 and/or the second set of resources 134-2. At block 1204, the first thread is yielded to a second thread of the threads generated from the loop. In some embodiments, the compiler 160 inserts a yield instruction into machine code included in the binary file to yield the first thread to the second thread. At block 1206, a second instruction included in the second thread is mapped to the first functional unit of the first processor. In some embodiments, the operating system of the compute device 142 or the second controller 340 maps the second instruction included in the second thread to the first functional unit of the processor.

In FIG. 12, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, application specific integrated circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., random access memory (RAM), read only memory (ROM), etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium (e.g., a computer-readable storage medium) comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in random access memory (RAM), flash memory, read only memory (ROM), electrically programmable ROM (EPROM), electrically erasable programmable ROM (EEPROM), registers, hard disk, a removable disk, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A method comprising:
identifying a first functional unit of a first processor that is underutilized for a first instruction included in a first thread of threads generated from a loop within source code;
yielding the first thread to a second thread of the threads generated from the loop; and
mapping a second instruction included in the second thread to the first functional unit of the first processor.

2. The method according to claim 1, further comprising mapping a third instruction included in a third thread of the threads generated from the loop to a second functional unit of the first processor.

3. The method according to claim 1, further comprising mapping a third instruction included in a third thread of the threads generated from the loop to a first functional unit of a second processor.

4. The method according to claim 3, wherein the first processor and the second processor are included in a base die that is attached to at least one a memory die.

5. The method according to claim 1, further comprising:
yielding the second thread to a third thread of the threads generated from the loop; and
mapping a third instruction included in the third thread to the first functional unit of the first processor.

6. The method according to claim 1, further comprising increasing a number of the threads generated from the loop.

7. The method according to claim 6, wherein increasing the number of the threads generated from the loop increases a utilization of a second functional unit of the first processor.

8. The method according to claim 6, wherein increasing the number of the threads generated from the loop increases a utilization of a first functional unit of a second processor.

9. A system comprising:
at least one memory;
at least one compute device coupled to the at least one memory, the at least one compute device configured to:
identify a first functional unit of a first processor that is underutilized based on a first yield added for a first thread of threads generated from a loop within source code;
add a second yield for a second thread of the threads generated from the loop; and
map an instruction included in a third thread of the threads generated from the loop to the first functional unit of the first processor.

10. The system according to claim 9, wherein the at least one compute device is further configured to cause generation of machine code based on the second yield.

11. The system according to claim 9, wherein the at least one compute device is further configured to map an additional instruction included in a fourth thread of the threads generated from the loop to a second functional unit of the first processor.

12. The system according to claim 9, wherein the at least one compute device is further configured to map an additional instruction included in a fourth thread of the threads generated from the loop to a first functional unit of a second processor.

13. The system according to claim 9, wherein the at least one compute device is further configured to increase a number of the threads generated from the loop.

14. The system according to claim 13, wherein increasing the number of the threads generated from the loop increases a utilization of a second functional unit of the first processor.

15. The system according to claim 13, wherein increasing the number of the threads generated from the loop increases a utilization of a first functional unit of a second processor.

16. The system according to claim 15, wherein the first processor and the second processor are included in a base die that is attached to at least one a memory die.

17. A non-transitory computer-readable storage medium storing instructions that, responsive to execution by a processor, cause the processor to perform operations comprising:
identifying a first functional unit of a first processor that is underutilized for a first instruction included in a first thread of threads generated from a loop within source code;
yielding the first thread to a second thread of the threads generated from the loop;
mapping a second instruction included in the second thread to the first functional unit of the first processor; and
causing generation of machine code based on mapping the second instruction to the first functional unit of the first processor.

18. The non-transitory computer-readable storage medium according to claim 17, wherein the machine code is generated based on the source code.

19. The non-transitory computer-readable storage medium according to claim 17, wherein the operations further comprise mapping a third instruction included in a third thread of the threads generated from the loop to a first functional unit of a second processor.

20. The non-transitory computer-readable storage medium according to claim 19, wherein the first processor and the second processor are included in a base die that is attached to at least one a memory die.
